(19) United States
(12) Patent Application Publication
(10) Pub. No.: US 2011/0027682 A1
(43) Pub. Date: Feb. 3, 2011

(54) PORTABLE ELECTRONIC DEVICE COMPRISING FUEL CELL POWER SYSTEM

(76) Inventors: Sung Han Kim, Seoul (KR); Jae Hyuk Jang, Gyunggi-do (KR); Jong Ho Chung, Gyunggi-do (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/551,305

(22) Filed: Aug. 31, 2009

(30) Foreign Application Priority Data
Jul. 28, 2009 (KR) 10-2009-0068843

(51) Int. Cl. H01M 8/04

(52) U.S. Cl. 429/463

(57) ABSTRACT

Disclosed herein is a portable electronic device including a fuel cell power system, including: a fuel storage tank for supplying fuel; a flat stack for generating electric energy using the fuel supplied from the fuel storage tank; a pressure control unit for controlling the pressure of the fuel supplied to the flat stack; a converter for converting the voltage of the electric energy generated from the flat stack; and a connector for transferring the electric energy converted through the converter to power terminals of the portable electronic device. The portable electronic device has optimal efficiency and is compatible with conventional portable electronic devices.

### CROSS REFERENCE TO RELATED APPLICATION

This application claims the benefit of Korean Patent Application No. 10-2009-0068843, filed Jul. 28, 2009, entitled “Portable electronic device having fuel cell power system”, which is hereby incorporated by reference in its entirety into this application.

### BACKGROUND OF THE INVENTION

1. Technical Field

The present invention relates to a portable electronic device comprising a fuel cell power system.

2. Description of the Related Art

Conventionally, a lithium ion battery has been generally used in order to supply electric energy to portable electronic devices. However, as portable electronic devices have high performance and perform a variety of functions, the conventional lithium ion battery is disadvantageous in that its operating time is limited and in that it is required to be charged for a long period of time. Therefore, a new energy source which can be used as a substitute for a lithium ion battery is being increasingly required, and a fuel cell is attracting considerable attention as a new energy source.

A fuel cell is an apparatus for directly converting the chemical energy of a fuel (hydrogen, LNG, LPG or the like) and air into electric energy and thermal energy through an electrochemical reaction. Differently from conventional electric power systems operated by the procedures of burning fuel, generating steam, driving a turbine and driving an electric generator, a fuel cell has high efficiency and does not cause environmental problems because it does not require a fuel burning procedure nor a driving device.

FIG. 1 is a view for explaining the operating principle of a fuel cell.

Referring to FIG. 1, an anode serves to decompose hydrogen (H₂) into hydrogen ions (H⁺) and electrons (e⁻). Hydrogen ions are transferred to a cathode 3 through an electrolyte 2. Electrons are converted into an electric current through an external circuit 4. In the cathode 3, hydrogen ions and electrons are reacted with oxygen (O₂) in air to produce water (H₂O). This chemical reaction in a fuel cell 10 is represented by Reaction Formula 1 below. However, Reaction Formula 1 is illustrative, and the chemical reactions occurring in each electrode are various depending on the kind of fuel cell.

Anode: H₂→2H⁺+2e⁻

Cathode: ½ O₂+2H⁺+2e⁻→H₂O

Total: H₂+½ O₂→H₂O [Reaction Formula 1]

That is, the electrons produced from the decomposition of hydrogen at the anode 1 are converted into an electric current through an external circuit 4, thus realizing the purpose and function of a fuel cell. Such a fuel cell 10 is advantageous in that air pollutants, such as SOₓ, NOₓ and the like, are discharged in small amounts, a very small amount of carbon dioxide is generated, and noise and vibration do not occur.

Meanwhile, there are various kinds of fuel cells, such as a phosphoric acid fuel cell (PAFC), an alkaline fuel cell (AFC), a polymer electrolyte membrane fuel cell (PEMFC), a direct methanol fuel cell (DMFC), a solid oxide fuel cell (SOFC) and the like. Among them, a polymer electrolyte membrane fuel cell (PEMFC) and a direct methanol fuel cell (DMFC), which can be advantageously miniaturized compared to other fuel cells, are attracting considerable attention as alternative means of conventional lithium ion batteries.

However, when fuel cells are employed in portable electronic devices, a technology for a fuel cell system which can exhibit high efficiency or a fuel cell system which has an optimal arrangement structure compatible with a conventional portable electronic device is still insufficient.

### SUMMARY OF THE INVENTION

Accordingly, the present invention has been made to solve the above-mentioned problems, and the present invention provides a fuel cell system which can supply electric energy to portable electronic devices at optimal efficiency and can be compatible with conventional portable electronic devices.

An aspect of the present invention provides a portable electronic device including a fuel cell power system, including: a fuel storage tank for supplying fuel; a flat stack for generating electric energy using the fuel supplied from the fuel storage tank; a pressure control unit for controlling the pressure of the fuel supplied to the flat stack; a converter for converting the voltage of the electric energy generated from the flat stack; and a connector for transferring the electric energy converted through the converter to power terminals of the portable electronic device.

Here, the portable electronic device may further include a housing formed in its body to a predetermined depth and a cover attached to and detached from a position corresponding to the housing; and the housing may be provided therein with the fuel storage tank and the pressure control unit, and the cover may be provided with the flat stack and the converter.

Further, the pressure control unit may be provided at one side thereof with the power terminals, and may be provided at the other side thereof with the fuel storage tank.

Further, the flat stack may be disposed such that it corresponds to an opening formed in the cover, and the converter may be disposed in contact with the inner side of the cover.

Further, the pressure control unit may include an inlet which is supplied with fuel from the fuel storage tank, a regulator which controls the pressure of the fuel, and an outlet which transfers the fuel to the flat stack.

Further, the outlet may include a fuel discharge pipe through which fuel is discharged, and the fuel discharge pipe may protrude into a space between one side of the fuel storage tank and one side of the housing.

Further, the fuel storage tank may be provided at one side thereof with a fuel supply pipe connected with the inlet to supply fuel to the pressure control unit, and the fuel supply pipe may be provided therein with a push switch for opening and closing the fuel supply pipe depending on whether or not the fuel supply pipe is connected with the inlet.

Further, in the push switch, when the inlet is detached from the fuel supply pipe, an elastic member pushes a rubber to the outside of the fuel storage tank to block the fuel supply pipe, and, when the inlet is connected with the fuel supply pipe, the inlet pushes the rubber to the inside of the fuel storage tank to open the fuel supply pipe.

Further, the fuel storage tank may be filled with metal hydride having hydrogen adsorptivity.

Further, the fuel storage tank may include a mesh filter which is provided at one side of the fuel supply pipe to prevent the powdered metal hydride from leaking.

Further, the flat stack may include: a membrane electrode assembly which includes an anode, a cathode, and an electrolyte membrane disposed between the anode and the cathode; collectors which are disposed at both outsides of the membrane electrode assembly and collect electric energy; gaskets which are interposed between the membrane electrode assembly and the collectors to seal space therebetween; and end plates formed at outsides of the collectors.

Further, the flat stack may be formed by connecting eight unit cells in series.

Further, the collectors may include an anode collector formed at the outside of the anode, and a cathode collector 252 formed at the outside of the cathode.

Further, the end plates may include a cathode end plate which is disposed at the outside of the cathode collector and supplied with air through air suction channels, and an anode end plate which is disposed at the outside of the anode collector and supplied with fuel through the fuel suction pipe.

Further, the anode end plate may be provided at one side thereof with a fuel exhaust pipe sealed with a sealing member.

Further, the fuel suction pipe may protrude into a space between one side of the fuel storage tank and one side of the housing.

Further, the converter may convert a voltage of 4.5˜9 V into a voltage of 3.5˜4 V.

Further, the connector may be a flexible printed circuit board.

Further, the connector may be inserted between the power terminals and the pressure control unit to transfer electric energy to the power terminals.

Further, the portable electronic device including a fuel cell power system may further include: a conductive plate having both sides perpendicular to each other, in which one side thereof is brought into contact with the power terminals and the other side thereof is exposed to the outside of the housing; and a protrusion terminal which is electrically connected with the conductive plate and protrudes in a direction of the cover, wherein the connector is brought into contact with the protrusion terminal to transfer electric energy to the power terminals.

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe the best method he or she knows for carrying out the invention.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view explaining the operating principle of a fuel cell;

FIGS. 2A and 2B are plan views showing the front and rear sides of a cover of a portable electronic device according to an embodiment of the present invention, respectively;

FIG. 3 is a plan view showing a body of a portable electronic device according to an embodiment of the present invention;

FIGS. 4A and 4B are perspective views showing pressure control units of a portable electronic device comprising a fuel cell power system, shown in FIG. 3;

FIG. 5 is an enlarged view showing the important part of a portable electronic device comprising the fuel cell power system shown in FIG. 3;

FIG. 6 is an exploded perspective view showing a fuel storage tank of a portable electronic device comprising the fuel cell power system shown in FIG. 3;

FIG. 7A is an exploded perspective view showing flat stacks of a portable electronic device comprising the fuel cell power system shown in FIG. 3;

FIG. 7B is a sectional view showing the membrane-electrode assembly shown in FIG. 7A; and

FIGS. 8A and 8B are perspective views showing methods of connecting a connector to the power terminals shown in FIG. 2.

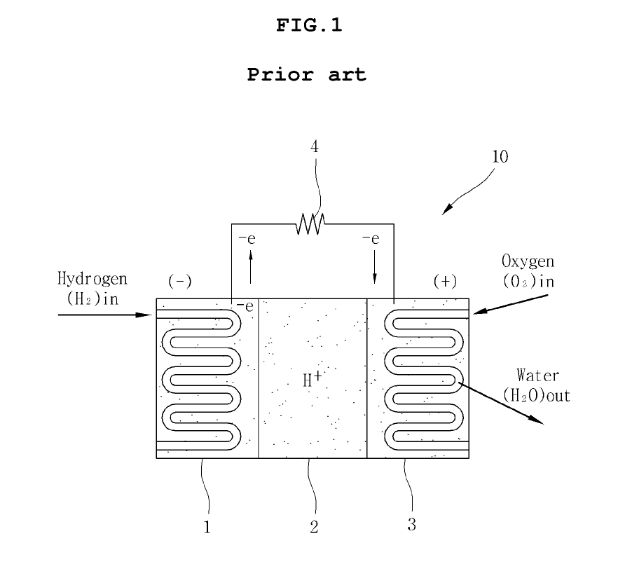

### DESCRIPTION OF THE PREFERRED EMBODIMENTS

The objects, features and advantages of the present invention will be more clearly understood from the following detailed description and preferred embodiments taken in conjunction with the accompanying drawings. Throughout the accompanying drawings, the same reference numerals are used to designate the same or similar components, and redundant descriptions thereof are omitted. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

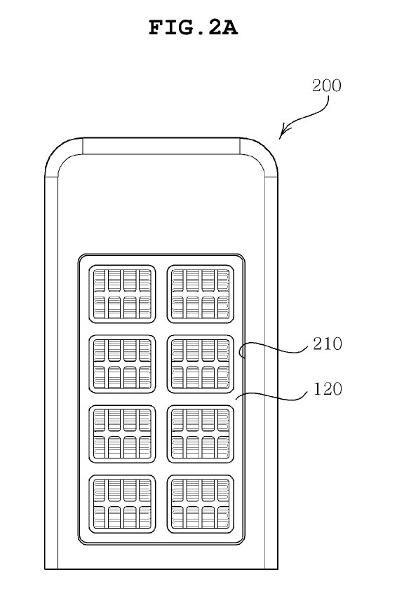

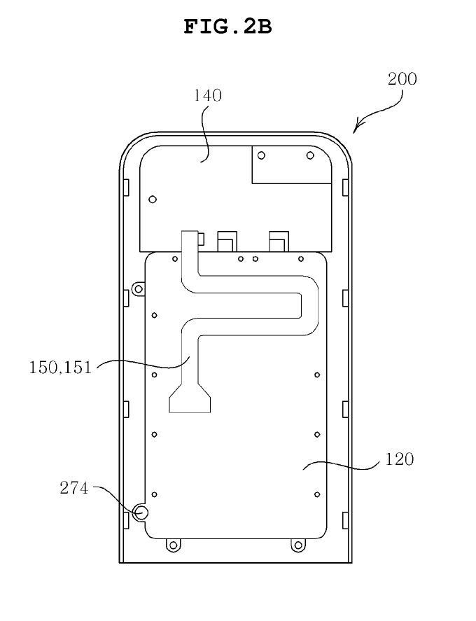

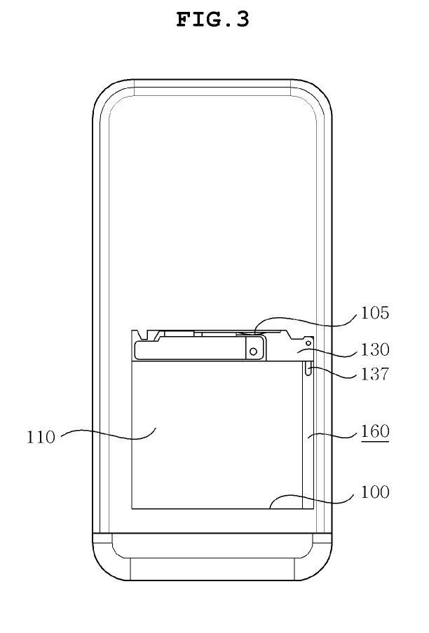

FIGS. 2A and 2B are plan views showing the front and rear sides of a cover of a portable electronic device according to an embodiment of the present invention, respectively, and FIG. 3 is a plan view showing a body of a portable electronic device according to an embodiment of the present invention. Hereinafter, a portable electronic device comprising a fuel cell power system according to the present invention will be described with reference to FIGS. 2 and 3.

As shown in FIGS. 2 and 3, a portable electronic device comprising a fuel cell power system according to the present invention includes a fuel storage tank 110 for supplying fuel, a flat stack 120 for generating electric energy using fuel supplied from the fuel storage tank 110, a pressure control unit 130 for controlling the pressure of the fuel supplied to the flat stack 120, a converter 140 for converting the voltage of the electric energy generated from the flat stack 120, and a connector 150 for transferring the electric energy converted through the converter 140 to power terminals 105 of the portable electronic device. Further, the portable electronic device may further include a housing 100 formed in a body to a predetermined depth and a cover 200 attached to and detached from the position corresponding to the housing 100. The housing 100 and cover 200 not only can be fabricated in an optimal size for employing a fuel cell system, but also can directly use a space for mounting a conventional lithium ion battery and a cover for covering the space.

As shown in FIG. 2, the cover 200 of the portable electronic device is provided with the flat stack 120 and converter 140, and the converter 140 is provided at one side thereof with the connector 150 for transferring electric energy to the power terminals 105 of the portable electronic device. In this case, the flat stack 120 is disposed at the position corresponding to an opening 210 of the cover 200 in order to be supplied with air from the outside. Further, it is preferred that the converter 140 be disposed in the cover 200 together with the flat stack 120 because the converter 140 must be supplied with the electric energy generated from the flat stack 120 through a collector 125. However, it is preferred that the converter 140 be disposed in contact with the inner side of the cover 200 instead of the opening 210 of the cover 200 in order to be protected from external shock.

As shown in FIG. 3, the housing 100 is formed in the body of the portable electronic device to a predetermined depth. The housing is provided therein with the fuel storage tank 110 and the pressure control unit 130. The pressure control unit 130 is provided at one side thereof with the power terminals 105, and is provided at the other side thereof with the fuel storage tank 110. In this case, it is preferred that the fuel storage tank 110 be detachably provided because it must be exchanged and charged. Further, it is preferred that the fuel storage tank 110 be fabricated such that its width is shorter than the width of the housing 100 in order to form a space 160 for accommodating a fuel discharge pipe 137 of the pressure control unit 130, a fuel suction pipe 274 of the flat stack 120 and a tube for connecting the fuel discharge pipe 137 with the fuel suction pipe 274. Hereinafter, the components of the portable electronic device comprising a fuel cell power system will be described with reference to the accompanying drawings.

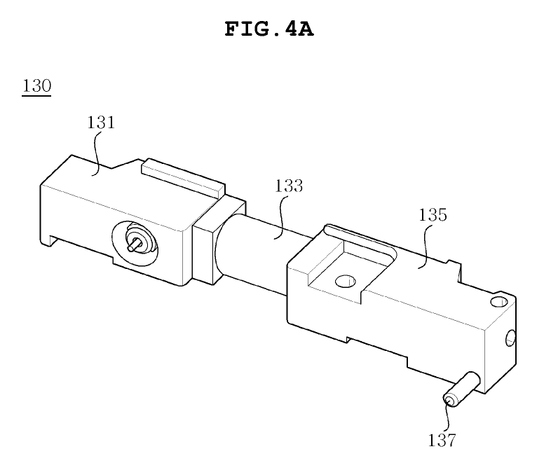

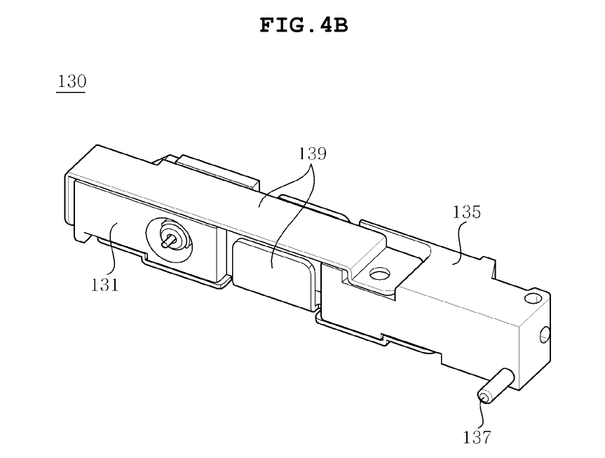

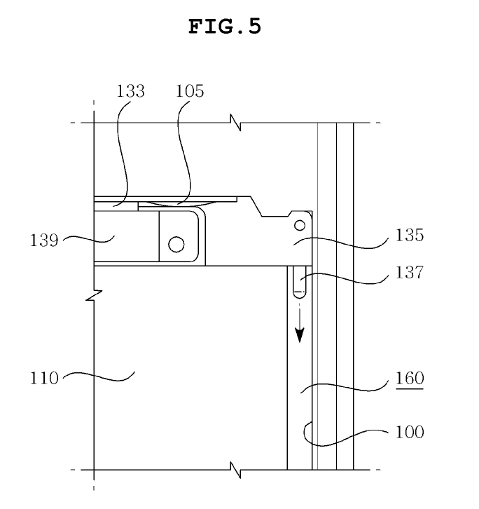

FIGS. 4A and 4B are perspective views showing pressure control units of a portable electronic device comprising the fuel cell power system shown in FIG. 3, and FIG. 5 is an enlarged view showing the important part of a portable electronic device comprising a fuel cell power system shown in FIG. 3. As shown in FIG. 4A, the pressure control unit 130 includes an inlet 131 which is supplied with fuel from the fuel storage tank 110, a regulator 133 which controls the pressure of the fuel, and an outlet 135 which transfers the fuel to the flat stack 120. Further, as shown in FIG. 4B, the pressure control unit 130 may further include connecting plates 139 in order to strengthen the connection between the inlet 131, the regulator 133 and the outlet 135.

The inlet 131 is connected with a fuel supply pipe 111 of the fuel storage tank 110 to be supplied with fuel. When the inlet 131 is connected with the fuel supply pipe 111, the fuel supply pipe 111, which was blocked by a push switch 113, is opened. The operation method thereof will be described later.

Since the pressure of the fuel stored in the fuel storage tank 110, which is about 1 MPa, is excessively high to directly supply this fuel to the flat stack 120, the regulator 133 serves to reduce the pressure of the fuel to be about 0.1 MPa. Here, the above pressure value is illustrative, and the regulator 133 can variously control the pressure of the fuel according to fuel component, the kind of the fuel storage tank 110, the kind of the flat stack 120, and the like.

The outlet 135 serves to supply the fuel whose pressure is controlled by the regulator 133 to the flat stack 120, and includes a fuel discharge pipe 137 through which fuel is discharged. As shown in FIG. 5, the fuel discharge pipe 137 may be formed such that it protrudes into the space 160 between one side of the fuel storage tank and one side of the housing 100. The fuel discharge pipe 137 is connected to the fuel suction pipe 274 with a tube to supply the fuel to the flat stack 120.

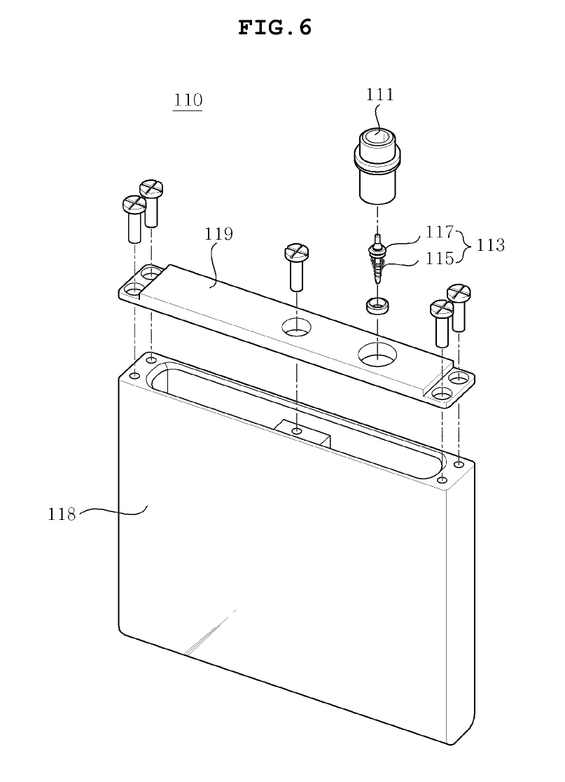

FIG. 6 is an exploded perspective view showing a fuel storage tank of a portable electronic device comprising the fuel cell power system shown in FIG. 3. As shown in FIG. 6, the fuel storage tank 110 includes a tank body 118 and a tank cover 119. The tank body 118 and the tank cover 119 are coupled with bolts or through welding such that the fuel storage tank 110 can semi-permanently withstand the high pressure of the fuel stored therein.

Further, the fuel storage tank is provided at one side thereof with a fuel supply pipe 111, and the fuel supply pipe 111 is connected with the inlet 131 to supply fuel to the pressure control unit 130. The fuel supply pipe 111 is provided therein with a push switch 113 for opening and closing the fuel supply pipe 111 depending on whether or not the fuel supply pipe 11 is connected with the inlet 131. Specifically, the push switch 113 includes an elastic rubber 115 and a rubber 117. In the push switch 113, when the inlet 131 is detached from the fuel supply pipe 111, the elastic member 115 pushes the rubber 117 to the outside of the fuel storage tank 110 to block the fuel supply pipe 111, and, when the inlet 131 is connected with the fuel supply pipe 111, the inlet 311 pushes the rubber 117 to the inside of the fuel storage tank 110 to open the fuel supply pipe 111. That is, when the fuel storage tank 110 is not mounted in a portable electronic device, the fuel supply pipe 111 is blocked to prevent the leakage of fuel, and, when the fuel storage tank 110 is mounted in the portable electronic device, the fuel supply pipe 111 is opened without performing an additional operation to supply the fuel to the pressure control unit 130.

Meanwhile, hydrogen (in the case of a polymer electrolyte membrane fuel cell) is used as the fuel stored in the fuel storage tank 110. When hydrogen is used as the fuel, in consideration of stability, metal hydride, which can reversibly adsorb and desorb hydrogen at low temperature and high pressure, may be used. Here, when the metal hydride is powdered, in order to prevent the metal hydride from leaking outward, a mesh filter may be provided at one side of the fuel supply pipe 111.

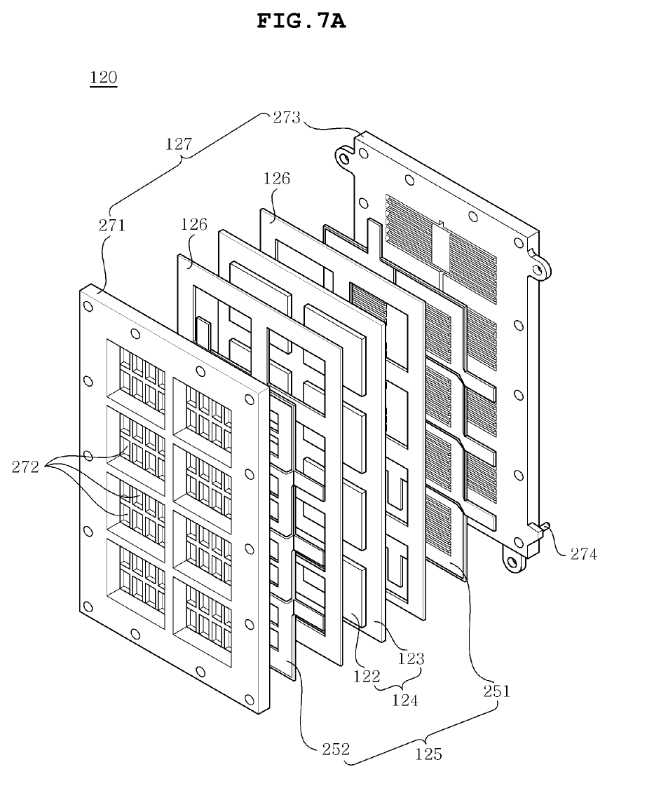

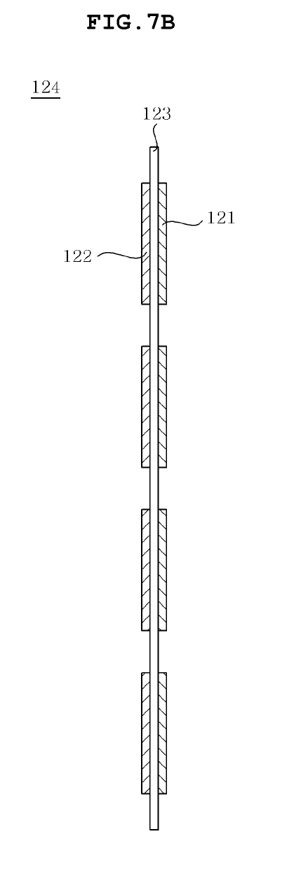

FIG. 7A is an exploded perspective view showing flat stacks of a portable electronic device comprising a fuel cell power system, shown in FIG. 3, and FIG. 7B is a sectional view showing a membrane-electrode assembly shown in FIG. 7A. As shown in HGS. 7A and 7B, the flat stack 120 includes: a membrane electrode assembly (MEA) 124 including an anode 121, a cathode 122, and an electrolyte membrane 123 located between the anode 121 and the cathode 122; collectors 125 which are located at both outsides of the membrane electrode assembly 124 and collect electric energy; gaskets 126 which are interposed between the membrane electrode assembly 124 and the collectors 125 to seal the spaces therebetween; and end plates 127 formed at outsides of the collectors 125.

Here, the membrane electrode assembly 124 is supplied with air through a cathode end plate 271 and is supplied with fuel through an anode end plate 273 to generate electric energy. Each of the cathode 122 and anode 121 may be formed into a unit electrode together with the electrolyte membrane, but, as shown in FIG. 7B, may be formed into a plurality of unit electrodes. The unit electrode of the anode 121, the unit electrode of the cathode 122 and the electrolyte membrane 123 serve as independent unit cells, respectively. The unit cells are connected in series to each other to increase the voltage. In particular, among portable electronic devices, mobile phones generally need a voltage of 3.5˜4.0 V. Therefore, it is preferred that eight unit cells be connected in series to each other in consideration of the power efficiency after the voltage has been dropped by a converter 140.

Meanwhile, the collectors 125 includes an anode collector 251 formed at the outside of the anode 121 and a cathode collector 252 formed at the outside of the cathode 122. The collectors 125 collect electric energy and then transfer it to the converter 140. Further, each of the collectors 125 may have a plurality of holes such that air or fuel can be easily supplied to the membrane electrode assembly 124.

The gaskets 126 may be interposed between the membrane electrode assembly 124 and the collectors 125 in order to efficiently generate electric energy. Since the gaskets 126 serve to prevent fuel or air from leaking from the flat stack 120, they may be made of an elastic material such as Teflon having excellent chemical resistance.

Since the end plates 127 serve to apply a proper pressure to a laminate from the outermost part of the flat stack 120, they must be slightly bent and must be insulated in order to prevent the phenomenon of an electrical short. Therefore, the end plates 127 may be made of a light metal such as aluminum, but may be insulated by coating them with Teflon in order to prevent the phenomenon of an electrical short.

The end plates 127 include a cathode end plate 271 which is disposed at the outside of the cathode collector 252 and supplied with air through air suction channels 272, and an anode end plate 273 which is disposed at the outside of the anode collector 251 and supplied with fuel through the fuel suction pipe 274. Here, the cathode end plate 271 is supplied with external air transferred through the opening 210 formed in the cover 200 through the air suction channels 272 and then transfers the external air to the cathode 122. Therefore, the present invention is advantageous in that an additional pump for introducing the external air is not required.

The anode end plate 273 is supplied with fuel through the fuel suction pipe 274 connected with the fuel discharge pipe 137 through a tube and then transfers the fuel to the anode 121. The fuel suction pipe 274, similarly to the above-mentioned fuel discharge pipe 137, is formed such that it protrudes the space 160 between one side of the fuel storage tank 110 and one side of the housing 100 of the body of the portable electronic device. That is, when the cover 200 is mounted in the housing 100, the fuel suction pipe 274, fuel discharge pipe 137 and tube are disposed in the space 160 between one side of the fuel storage tank 110 and one side of the housing 100, thus enabling the space 160 to be efficiently used. Meanwhile, the anode end plate 273 is provided at one side thereof with a fuel exhaust pipe, and the fuel exhaust pipe serves to discharge the fuel remaining in the anode 121 after reaction. However, since the portable electronic device does not have a space sufficient for storing a large amount of fuel, if necessary, the fuel exhaust pipe is sealed with a sealing member such as a bolt having no head or the like, thus decreasing the consumption of fuel.

Meanwhile, the converter 140 serves to convert the voltage of the electric energy generated from the flat stack 120 into a voltage necessary for a portable electronic device. The converter 140 must be connected with the collectors 125 in order to be supplied with electric energy from the flat stack 120. In this case, the converter 140 may be connected with the collectors 125 by directly bringing the collectors 125 into contact with the converter 140 due to the extension of the collectors 125 or by using an additional electric wire, but the present invention is not limited thereto, and a variety of electrical connection means may be used.

Further, as described above, when eight unit cells are connected in series in order to realize optimal power efficiency, portable electronic devices generally need a voltage of 4.5˜9.0 V, and, particularly, mobile phones generally need a voltage of 3.5˜4.0 V. Therefore, it is preferred that a converter 140, which can reduce the voltage according to these conditions, be used.

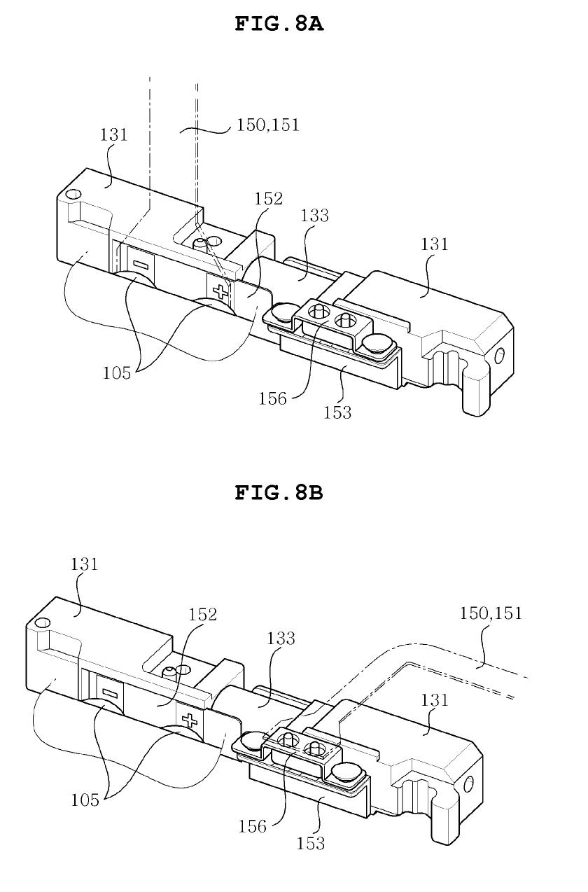

FIGS. 8A and 8B are perspective views showing methods of connecting a connector to power terminals, shown in FIG. 2. The connector 150 serves to transfer electric energy from the converter 140 to the power terminals 105. As shown in FIGS. 8A and 8B, a flexible printed circuit board (FPCB) 151 whose shapes are freely changed and which can easily transfer electric energy may be used as the connector 150. In this case, the converter 140 is electrically connected to one end of the flexible printed circuit board 151, and the power terminals are electrically connected to the other end thereof using various methods. Here, the flexible printed circuit board 151 and the power terminals may be selectively connected or separated according to the needs of users. Further, the flexible printed circuit board 151 may be coated with an insulating material in order to prevent the flexible printed circuit board 151 facing the flat stack 120 from being shorted when the cover 200 is mounted in the housing 100.

Specifically, in a method of connecting the flexible printed circuit board 151, as shown in FIG. 8A, one end of the flexible printed circuit board 151 is connected to the converter 140, and the other end thereof is inserted between the power terminals 105 and the pressure control unit 130. In this case, since the other end of the flexible printed circuit board 151 is brought into contact with the power terminals 105, the flexible printed circuit board can transfer electric energy to the power terminals 105. Further, in order to completely attach the other end of the flexible printed circuit board 151 to the power terminals 105, the pressure control unit 130 may be additionally provided with a guide member 152. This method is advantageous in that electric energy is continuously supplied to a portable electronic device because the electrical connection between the flexible printed circuit board 151 and the power terminals 105 is maintained even when the cover 200 is separated.

In another method of connecting the flexible printed circuit board 151, as shown in FIG. 8B, one side of the flexible printed circuit board 151 is brought into contact with the power terminals 105 and the other side thereof is exposed to the outside of the housing 100 using a conductive plate 153, both sides of which are perpendicular to each other. In this case, as shown in FIG. 8B, the guide member 152 extending to one side of the conductive plate 153 may also be used. The conductive plate 153 is provided at the other side thereof with a protrusion terminal 156 protruding in the direction of the cover 200, and the protrusion terminal 156 is electrically connected with the conductive plate 153. That is, the conductive plate 153 and protrusion terminal 156 serve to extend the electrical connection of the power terminals 105 to the outside of the housing 100. Therefore, when the flexible printed circuit board 151 is brought into contact with the protrusion terminal 156, electric energy is transferred to the power terminals 105 through the conductive plate 153 and protrusion terminal 156. Further, when the flexible printed circuit board 151 is fixed on the flat stack 120 such that it corresponds to the protrusion terminal 156 and then the cover 200 is mounted in the housing 100, the flexible printed circuit board 151 is brought into contact with the protrusion terminal 156 without additional operation. This method is advantageous in that the flexible printed circuit board 151 is not required to be inserted between the power terminals 105 and the pressure control unit 130 and in that the flexible printed circuit board 151 is electrically connected with the power terminals 105 only by mounting the cover 200 in the housing 100.

It is not necessary to select one of the above-mentioned two methods. As shown in FIGS. 8A and 8B, when the guide member 152 extends to one side of the conductive plate 153, a portable electronic device can be manufactured using these two methods at the same time.

Further, in the present invention, although the flexible printed circuit board 151 is illustrated as an example of the connector 150, Examples of the collector 150 may include, but are not limited to, all electrically-connectable means such as an electric wire, a rigid printed circuit board, a rigid-flexible printed circuit board and the like.

As described above, since the portable electronic device according to the present invention employs a fuel cell power system instead of a lithium ion battery, it can be used for a long period of time, and its charging time can be reduced.

Further, since the fuel cell power system according to the present invention is compatible with a conventional portable electronic device, it is not required to change the structure and shape of the portable electronic device, thus decreasing the production costs thereof.

Furthermore, according to the present invention, since a conventional lithium ion battery can be temporarily used when the fuel of a fuel cell is completely consumed and cannot be easily charged, the portable electronic device of the present invention can be put to practical use even before facilities for charging fuel are sufficiently equipped.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

Simple modifications, additions and substitutions of the present invention belong to the scope of the present invention, and the specific scope of the present invention will be clearly defined by the appended claims.

What is claimed is:

1. A portable electronic device including a fuel cell power system, comprising:
a fuel storage tank for supplying fuel;
a flat stack for generating electric energy using the fuel supplied from the fuel storage tank;
a pressure control unit for controlling the pressure of the fuel supplied to the flat stack;
a converter for converting the voltage of the electric energy generated from the flat stack; and
a connector for transferring the electric energy converted through the converter to power terminals of the portable electronic device.

2. The portable electronic device including a fuel cell power system according to claim 1, wherein the portable electronic device further comprises a housing formed in its body to a predetermined depth and a cover attached to and detached from a position corresponding to the housing, and
the housing is provided therein with the fuel storage tank and the pressure control unit, and the cover is provided with the flat stack and the converter.

3. The portable electronic device including a fuel cell power system according to claim 2, wherein the pressure control unit is provided at one side thereof with the power terminals, and is provided at the other side thereof with the fuel storage tank.

4. The portable electronic device including a fuel cell power system according to claim 2, wherein the flat stack is disposed such that it corresponds to an opening formed in the cover, and the converter is disposed in contact with the inner side of the cover.

5. The portable electronic device including a fuel cell power system according to claim 1, wherein the pressure control unit comprises:
an inlet which is supplied with fuel from the fuel storage tank;
a regulator which controls the pressure of the fuel; and
an outlet which transfers the fuel to the flat stack.

6. The portable electronic device including a fuel cell power system according to claim 5, wherein the outlet comprises a fuel discharge pipe through which fuel is discharged, and the fuel discharge pipe protrudes into a space between one side of the fuel storage tank and one side of the housing.

7. The portable electronic device including a fuel cell power system according to claim 5, wherein the fuel storage tank is provided at one side thereof with a fuel supply pipe connected with the inlet to supply fuel to the pressure control unit, and
the fuel supply pipe is provided therein with a push switch for opening and closing the fuel supply pipe depending on whether or not the fuel supply pipe is connected with the inlet.

8. The portable electronic device including a fuel cell power system according to claim 7, wherein, in the push switch, when the inlet is detached from the fuel supply pipe, an elastic member pushes a rubber to outside of the fuel storage tank to block the fuel supply pipe, and, when the inlet is connected with the fuel supply pipe, the inlet pushes the rubber to inside of the fuel storage tank to open the fuel supply pipe.

9. The portable electronic device including a fuel cell power system according to claim 1, wherein the fuel storage tank is filled with metal hydride having hydrogen adsorptivity.

10. The portable electronic device including a fuel cell power system according to claim 9, wherein the fuel storage tank comprises a mesh filter which is provided at one side of the fuel supply pipe to prevent the powdered metal hydride from leaking.

11. The portable electronic device including a fuel cell power system according to claim 1, wherein the flat stack comprises:
a membrane electrode assembly which includes an anode, a cathode, and an electrolyte membrane disposed between the anode and the cathode;
collectors which are disposed at both outsides of the membrane electrode assembly and collect electric energy;
gaskets which are interposed between the membrane electrode assembly and the collectors to seal spaces therebetween; and
end plates formed at outsides of the collectors.

12. The portable electronic device including a fuel cell power system according to claim 11, wherein the flat stack is formed by connecting eight unit cells in series.

13. The portable electronic device including a fuel cell power system according to claim 11, wherein the collectors include an anode collector formed at the outside of the anode, and a cathode collector 252 formed at the outside of the cathode.

14. The portable electronic device including a fuel cell power system according to claim 11, wherein the end plates include a cathode end plate which is disposed at the outside of the cathode collector and supplied with air through air suction channels, and an anode end plate which is disposed at the outside of the anode collector and supplied with fuel through the fuel suction pipe.

15. The portable electronic device including a fuel cell power system according to claim 14, wherein the anode end plate is provided at one side thereof with a fuel exhaust pipe sealed with a sealing member.

16. The portable electronic device including a fuel cell power system according to claim 14, wherein the fuel suction pipe protrudes into a space between one side of the fuel storage tank and one side of the housing.

17. The portable electronic device including a fuel cell power system according to claim 11, wherein the converter converts a voltage of 4.5˜9 V into a voltage of 3.5˜4 V.

18. The portable electronic device including a fuel cell power system according to claim 1, wherein the connector is a flexible printed circuit board.

19. The portable electronic device including a fuel cell power system according to claim 3, wherein the connector is inserted between the power terminals and the pressure control unit to transfer electric energy to the power terminals.

20. The portable electronic device including a fuel cell power system according to claim 3, further comprising:
a conductive plate having both sides perpendicular to each other, in which one side thereof is brought into contact with the power terminals and the other side thereof is exposed to outside of the housing; and
a protrusion terminal which is electrically connected with the conductive plate and protrudes in a direction of the cover,
wherein the connector is brought into contact with the protrusion terminal to transfer electric energy to the power terminals.
